(19) United States
(12) Patent Application Publication
(10) Pub. No.: US 2016/0245635 A1
(43) Pub. Date: Aug. 25, 2016

(54) TAPE SQUARE

(71) Applicant: Lon CRAMER, Cordes Lakes, AZ (US)

(72) Inventor: Lon CRAMER, Cordes Lakes, AZ (US)

(21) Appl. No.: 14/629,161

(22) Filed: Feb. 23, 2015

(51) Int. Cl. G01B 3/10

(52) U.S. Cl. CPC G01B 3/1041; G01B 3/1084; G01B 2003/1089

(57) ABSTRACT

By configuring a tape measure HOUSING into a speed square; It becomes a one step tool that measures and marks simultaneously a perfect 90% butt cut onto linial material stock that is to be cut, using a hand held saw. Eliminating ONE STEP and ONE TOOL.

This tool is also intended to facilitate the notching of construction Paneling.

### BACKGROUND OF THE INVENTION

There are many shortcomings in existing construction tools

this idea came about as a result of having to carry to many tools in already over crowded and heavy tool bags; And having to employ each separate tool (tape measure to measure-square to mark the cut) as a two step procedure involving retreating and replacing first the tape measure to measure and mark—then retreating and replacing the square to effect a perfect butt cut to guide upon the work by utilizing a hand held framing saw.

This innovation—although designed for the framing trade is applicable to carpentry and general handy man applications—anywhere a one step measure and mark procedure would simplify the job.

### BRIEF SUMMERY OF THE INVENTION

Why shouldn't the tape measure housing be so configured so as to become a tool itself? could then it not only be so configured so to accomplish the task of the speed square that is used in conjunction with the tape measure that would ELIMINATE A STEP & A TOOL in the process of marking a perfect square line @ the right dimension on to the lineal material to be cut?

### BRIEF DESCRIPTION OF DRAWINGS

FIG. 4: shows how the speed square width has been modified to accommodate a tape measure placed within two halves to form a tape measure housing—notice the tape measure tip location and integration into the square.

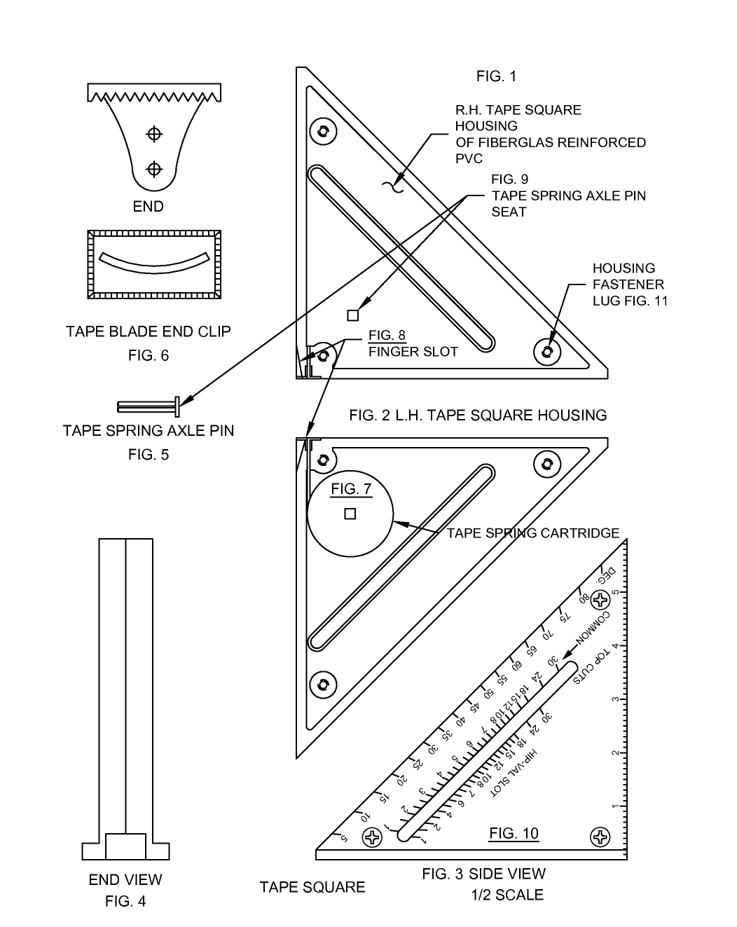

FIG. 3: Shows the normally open triangle finger hole blanked off to accommodate the mounting location of the Tape/spring cartilage. Notice that the Hip Vally site slot is retained unaltered.

FIG. 1: Tape square housing half: Shows—blanked off triangle finger hole with square axle pin seat that is the axis of the tape/spring cartridge location.

FIG. 2: Tape square housing half: Shows the Tape/Spring cartilage mounted in the Tape Square housing half: notice the tape measure end clip seat location

FIG. 6: Shows Tape blade end clip configuration, so as to catch the work regardless of the orientation of the tape square—(Top & side views)

FIG. 5: Shows conventional slotted axle pin: (end and side views) upon which winds a tape retracting

FIG. 7: Shows a conventional tape spring reel—As mounted into the L.H. Tape Square housing

FIG. 8: Finger slot to access tape blade end clip

FIG. 9: Scroll spring pin seat

FIG. 10: Hip/valley scales—slot

FIG. 11: Housing fastener Lug

### SPECIFICATIONS

So as to form the tape measure housing into a speed square configuration; the tape measure housing should be expanded to the form of an equal lateral right triangle, with an X and Y cordinance measuring 7″ and the hypotenuse-scaled with degrees starting from 0 Degrees @ X coordinence to 90 degrees @ Y coordinence with a Hip—Valley site slot (Side View detail from drawing).

The width of the housing (End View detail from drawing) is determined by a conventional Tape/Spring cartridge width with an additional 0.010″ clearance—both sides inside width. total outside width to be an additional Approx. 2×0.040″ housing thickness—split in half in the orthodox manner of tape measure housing construction—where as the tape measure spring/tape cartridge is mounted inside said housing; located @ the blinded off grab opening triangle. the exact location of the tape/spring cartirage axle pin is determined by the tangential exit for the tape being at a right angle to the Y axis with the tape end clip positioned flush with the base of the square (X axis). Because the tape clip cannot protrude past the base of the square a finger slot must be cast into the housing @ the tape clip seat. see R.H. Tape Square body housing body half drawing

Due to the expanded width of placing a tape measure “inside” a conventional speed square all of the scales need to be projected across the face of the increased width to connect one scale to the other to eliminate paralax so that the desired degree can be aligned to the work that the other side of the square housing rests against.

A high impact housing material such as a fiberglass reinforced PVC is recommended for non-breakage when accidentally dropped onto concrete slabs that will be the scenario of its working environment.

Typical state of the art tape/spring cartridge is to be employed into the Tape Square assembly as shown in the drawing—“Tape Square body housing half”

A conventional recoil spring split axle retainer pin is used for the tape spring cartridge axle: see drawing.

The tape end clip is to be made with medium fine teeth so as to stay affixed to the work, that form a continuous 360% perimeter top & bottom both side square rim of teeth to catch the work regardless of the orientation of the tape measure: see Tape end clip detail drawing.

1. That the novelty of this tool qualifies as my intellectual property due to my ingenuity of combining two separate tools into a symbiotic ONE TOOL—that both eliminates one tool and one step: reducing construction tool bag clutter and drastically speeding up the measuring—marking—two step procedure into one step—MEASURE AND MARK SIMULTANEOUSLY. that here to fore tape measure housings have not been configured into tools themselves; such as but not limited to a “speed square”.
